(19) United States
(12) Patent Application Publication
(10) Pub. No.: US 2020/0340794 A1
(43) Pub. Date: Oct. 29, 2020

(54) METHOD AND APPARATUS FOR MEASURING ANGLE BETWEEN TWO BODIES OF FOLDABLE DEVICE

(71) Applicant: ILJIN Materials Co., Ltd., Iksan-si (KR)

(72) Inventor: Jungwon Park, Iksan-si (KR)

(73) Assignee: ILJIN Materials Co., Ltd., Iksan-si (KR)

(21) Appl. No.: 16/724,928

(22) Filed: Dec. 23, 2019

(30) Foreign Application Priority Data
Apr. 29, 2019 (KR) 10-2019-0049703
Sep. 18, 2019 (KR) 10-2019-0114636

(51) Int. Cl. G01B 7/30; G01D 5/14; G01D 5/16

(52) U.S. Cl. CPC G01B 7/30; G01D 5/16; G01D 5/142

(57) ABSTRACT

An apparatus is provided comprising: a first body part; a second body; a first magnetic sensor unit disposed in the first body part, the first magnetic sensor unit being configured to: detect an intensity of an external magnetic field applied to the first magnetic sensor unit, and generate first azimuth information representing a direction in which the first body part is oriented; a second magnetic sensor unit disposed in the second body, the second magnetic sensor unit being and configured to detect an intensity of an external magnetic field applied to the second magnetic sensor unit, and generate second azimuth information representing a direction in which the second body part is oriented; and a control unit configured to receive the first and second azimuth information from the first and second magnetic sensor units, respectively, and calculate an angle between the first and second body parts.

### CROSS-REFERENCE TO RELATED APPLICATION

This application claims priority under 35 USC § 119 to Korean Patent Application No. 10-2019-0049703 filed on Apr. 29, 2019 and Korean Patent Application No 10-2019-0114636 filed on Sep. 18, 2019 in the Korean Intellectual Property Office (KIPO), the entire disclosure of which is incorporated herein by reference.

### BACKGROUND

A variety of apparatuses or devices are used in which two components make relative rotational movements about one central axis so that the angle between the two components may be changed. That is, side parts of the two components may be rotatably coupled to each other by a coupling shaft, and folded or unfolded about the coupling shaft as needed. Examples of such a foldable structure may include a robot device that includes first and second robot arm members axially coupled to each other such that the angle therebetween is changeable, a hinged door that includes a door frame and a door rotatably coupled to the door frame to be opened or closed, and the like. Representative examples of electronic devices having the foldable structure include a laptop computer, a foldable tablet computer, and the like.

Recently, there is also planned to commercially launch a foldable smartphone in which two bodies are combined into a foldable structure through a coupling shaft and that employs a flexible, bendable or rollable display (hereinafter collectively referred to as “foldable display”). In future, various products equipped with foldable displays may be launched. For example, an electronic device to which a foldable display is applied may employ a plurality of displays to independently output a plurality of screens or to divide and output one screen, and two components of the foldable device of the plurality of displays may be coupled to each other, for example, by a hinge structure such that the two components can be foldable relative to each other.

In an apparatus, device, or the like having a foldable structure, predetermined follow-up measures (necessary operations, processes, controls, etc.) may be taken according to the size of the angle between the two components. For example, when the closed door is rotated so that the dihedral angle between the door and the door frame has a predetermined angle or more, it is determined that the door is opened, so that necessary measures (e.g., an alarm output indicating that the door is unwillingly opened) may be taken. For example, according to the size of the angle between the first and second robot arm members axially coupled to each other, a predetermined operation of a robot device may be performed or the dihedral angle data may be provided to the outside.

In addition, for example, there may be required a function of outputting various user interfaces (UIs) according to an angle (i.e., an opening angle or a folding angle) between two components of a foldable electronic device. For example, in the case of a foldable smartphone, a display unit provided on two body parts may have different usage forms when the two body parts are folded and unfolded. That is, in the folded state, the display unit may be divided into two display areas which are used as an independent display screen of each body part, and in the unfolded state, the display unit may function as one screen.

As described above, in various foldable devices, it is often necessary to make a decision or process according to the size of the angle between two components. For example, the UI may be variably applied according to the opening angle between two body parts of a foldable smartphone. Therefore, there is a need to provide a technology capable of accurately measuring the angle between two components constituting a foldable structure in real time.

A posture or an orientation of a portable foldable electronic device may be frequently changed in use, and the angle between the two components may be changed as the posture or orientation is changed. Thus, there is a need to provide a technology capable of accurately measuring the angle between two components in real time even in such a situation.

A technique for measuring an angle between two displays by using two acceleration sensors or one acceleration sensor and one angular velocity sensor is disclosed in Korean Unexamined Patent Publication No. 10-2017-0031525. However, this technique has the following technical limitations. In the case of using the acceleration sensor, when the whole or a part of the foldable device as well as the body part provided with the acceleration sensor performs an acceleration movement, the acceleration sensor may not accurately recognize the direction of the gravity acceleration, thereby causing an error in the rotation angle measurement.

In the case of using one acceleration sensor and one angular velocity sensor, the angle between two displays may be measured in a state where the power is turned on. However, when the power supply to the angular velocity sensor is turned off and then on again, the angular velocity sensor cannot measure the angle between the two components at a time point when the power supply is turned on. In a state where it is impossible to measure the angle between the two components formed at the present time, it is not possible to accurately measure the angle between the two components only by calculating the displacement of the rotation angle of the component provided with the acceleration sensor.

### SUMMARY

According to aspects of the disclosure, an apparatus is provided comprising: a first body part; a second body part that is rotatably coupled to the first body part; a first magnetic sensor unit disposed in the first body part, the first magnetic sensor unit being configured to: detect an intensity of an external magnetic field applied to the first magnetic sensor unit, and generate first azimuth information representing a direction in which the first body part is oriented; a second magnetic sensor unit disposed in the second body, the second magnetic sensor unit being and configured to detect an intensity of an external magnetic field applied to the second magnetic sensor unit, and generate second azimuth information representing a direction in which the second body part is oriented; and a control unit configured to receive the first and second azimuth information from the first and second magnetic sensor units, respectively, and calculate an angle between the first and second body parts.

According to aspects of the disclosure, a method of measuring an angle between first and second body parts of a foldable device is provided, comprising: generating first azimuth information representing a direction in which the first body part is oriented based on an intensity of an external magnetic field at a first magnetic sensor unit, the first magnetic sensor unit being disposed in the first body part; generating second azimuth information representing a direction in which the second body part is oriented based on an intensity of the external magnetic field at a second magnetic sensor unit, the second magnetic sensor unit being disposed in the second body part; and calculating, by a control unit, an angle between the first and second body parts by using the first and second azimuth information received from the first and second magnetic sensor units.

### BRIEF DESCRIPTION OF THE DRAWINGS

FIG. 1 is a block diagram of an apparatus for measuring an angle between two body parts of a foldable structure, according to an exemplary embodiment;

FIG. 2 is a diagram of a portable foldable device incorporating the apparatus of FIG. 1, according to an exemplary embodiment;

FIG. 3 is a diagram of an example a triaxial magnetic fluxgate sensor unit, according to an exemplary embodiment;

FIG. 4 is a diagram of an example a triaxial magnetic fluxgate sensor unit, according to an exemplary embodiment;

FIG. 5 is a block diagram of an apparatus for measuring an angle between two body parts of a foldable device, according to an exemplary embodiment;

FIG. 6 is a diagram illustrating the operation of fluxgate elements for measuring the intensity of an externally applied magnetic field, according to an exemplary embodiment;

FIG. 7 is a flowchart of an example of a process, according to an exemplary embodiment;

FIG. 8 is a plot illustrating the relationship between a driving current and a pickup signal that is generated in response to the driving current, according to an exemplary embodiment;

FIG. 9 is a flowchart of an example of a process, according to an exemplary embodiment;

FIG. 10 is a flowchart of an example of a process, according to an exemplary embodiment;

FIG. 11 is a is a diagram illustrating a process for calibrating a magnetic fluxgate sensor unit according to an exemplary embodiment;

FIG. 12 is a flowchart of an example of a process, according to an exemplary embodiment; and

FIG. 13 is a plot illustrating the accuracy of a process for measuring an angle between two body parts of a foldable device, according to an exemplary embodiment.

### DETAILED DESCRIPTION

Various example embodiments will be described more fully with reference to the accompanying drawings, in which embodiments are shown. This inventive concept may, however, be embodied in many different forms and should not be construed as limited to the embodiments set forth herein.

Rather, these embodiments are provided so that this disclosure will be thorough and complete, and will fully convey the scope of the inventive concept to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the inventive concept. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The above and other features of the inventive concept will become more apparent by describing in detail example embodiments thereof with reference to the accompanying drawings. The same reference numerals are used for the same elements in the drawings and redundant explanations for the same elements are omitted.

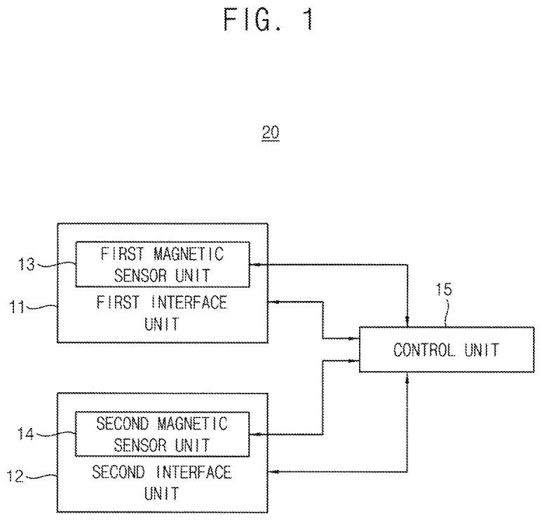

FIG. 1 is a block diagram illustrating a configuration of an apparatus for measuring an angle between two body parts coupled in a foldable structure according to an exemplary embodiment.

Referring to FIG. 1, an apparatus 20 for measuring a dihedral angle of a foldable device according to an exemplary embodiment may include a first magnetic sensor unit 13, a second magnetic sensor unit 14, and a control unit 15. The first and second magnetic sensor units 13 and 14 may be installed on first and second body parts of the foldable device, respectively, and foldably coupled to one another.

In an exemplary embodiment, the first and second magnetic sensor units 13 and 14 may be implemented with vector magnetometers for measuring the components of the earth's magnetic field. Azimuth and inclination angles may be measured by using components of magnetic field intensity measured using three orthogonal vector magnetic sensor units. The vector magnetic sensor unit applicable to the present disclosure may include a rotating coil magnetometer, a Hall Effect magnetometer, a magneto-resistive device, a fluxgate magnetometer, and the like. However, the present disclosure is not limited thereto, and any magnetic sensors capable of detecting geomagnetism may be used as the magnetic sensor unit of the present disclosure.

The first and second magnetic sensor units 13 and 14 may detect the position of the first and second body parts, respectively, to generate first and second azimuth information indicating directions in which the first and second body parts are oriented. The first and second azimuth information may be output to the control unit 15.

The control unit 15 may calculate an angle between the first and second body parts by using the azimuth information provided by the first and second magnetic sensor units 13 and 14. The control unit 15 may be implemented as a hardware component, a software component, and/or a combination of hardware components and software components. For example, the control unit 15 may be implemented with a central processing unit (CPU), a processor, a system-on-chip (SoC), a control unit, an arithmetic logic unit (ALU), a digital signal processor, a microcomputer, a field programmable array (FPA), a programmable logic unit (PLU), a microprocessor, or hardware such as another device capable of executing and responding to instructions, and software having a predetermined function. The software may include various functions described below, including a function of calculating an angle between two body parts using the first and second azimuth information.

In an exemplary embodiment, the dihedral angle measuring apparatus 20 may further include first and second interface units 11 and 12. Each of the first and second interface units 11 and 12 may receive a predetermined instruction or request from a user and transmit the predetermined instruction or request to the control unit 15. In addition, each of the first and second interface units 11 and 12 may output information that is generated by the control unit 15 in response to the received instruction or request. The first and second interface units 11 and 12 may be part of the first and second body parts of the foldable device.

For example, the first interface unit 11 may include an input device such as a keyboard for receiving user input, and the second interface unit 12 may include a display unit for outputting information generated in response to the user input. In some implementations, the foldable device 10 may include an electronic device such as a laptop computer. As another example, the first and second interface units 11 and 12 may include touch screen units implemented with a display such as an LCD, an LED, an OLED, or the like. The first and second interface units 11 and 12 may together form a touch screen interface. In some implementations, the foldable device 10 may be implemented as an electronic device such as a foldable smartphone or a foldable tablet PC.

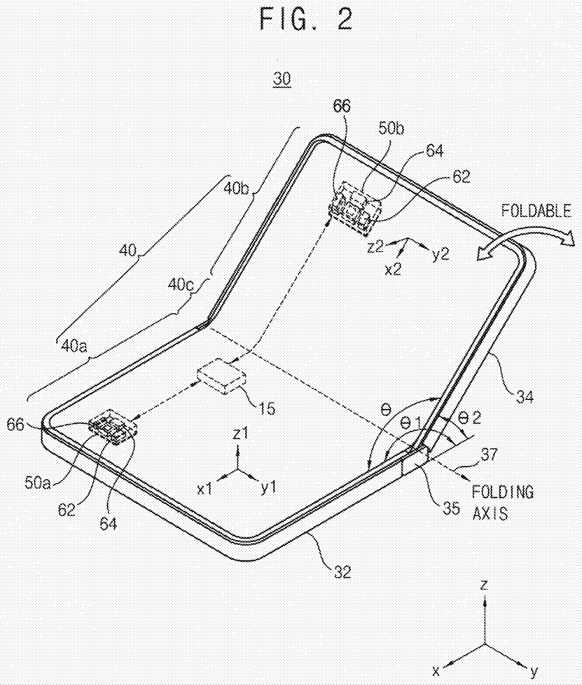

FIG. 2 is a diagram of an example of a portable foldable device 30 that incorporates the dihedral angle measuring apparatus 20 of FIG. 1. As illustrated, the portable foldable device 30 may include first and second body parts 32 and 34, a connection unit 35, and a flexible display 40. The first and second body parts 32 and 34 may be connected to each other through a connection unit 35. The connection unit 35 may be disposed between one side of the first body part 32 and one side of the second body part 34 and serve as a physical coupling structure that allows the two body parts to be folded or unfolded with respect to each other. In addition, the first and second body parts 32 and 34 may be folded or unfolded about the connection unit 35. That is, the first and second body parts 32 and 34 may be configured such that the angle θ can be changed between a folded position and an unfolded position. The first and second body parts 32 and 34 may have a flat-plate shape. The flexible display 40 may be disposed to cover all of one side surfaces of the first and second body parts 32 and 34 and the connection unit 35. In an exemplary embodiment, the first and second body parts 32 and 34 may be directly connected to each other without a separate connection unit 35. In this case, a boundary line between the first and second body parts 32 and 34 may serve as the folding axis 37.

The connection unit 35 may be implemented, for example, as a hinge structure (mechanism). The hinge structure is connected to each of the first and second body parts 32 and 34, and allows the first and second body parts 32 and 34 to be transitioned from a folded state (dihedral angle θ=0° to an unfolded state (dihedral angle θ=180° or vice versa. Specific examples of a hinge structure are disclosed in U.S. Patent Publication No. 2017/0364123A, titled “FOLDABLE DEVICE”, U.S. Patent Publication No. 2018/0024593A, titled “FOLDABLE ELECTRONIC DEVICE INCLUDING FLEXIBLE DISPLAY ELEMENT”, and U.S. Patent Publication No. 2019/0079561A, titled “FOLDABLE DEVICE,” the contents of which are herein incorporated by reference.

The first and second interface units 11 and 12 may be implemented in various forms. In an exemplary embodiment, the first and second interface units 11 and 12 may be implemented as touch screen units. For example, the control unit 15 may control the first and second interface units 11 and 12 such that the first and second interface units 11 and 12 operate as separate interface units independent from each other when the angle (θ) between the first and second body parts 32 and 34 is smaller than a predetermined angle. When the interface units 11 and 12 operate as separate interface units, one flexible display 40 may be functionally divided about the connection unit 35 to function as a display 40a for the first interface unit and a display 40b for the second interface unit 12. Additionally or alternatively, when the interface units 11 and 12 operate as separate interface units, the display 40c on the connection unit 35 may be turned off

When the angle θ between the first and second body parts 32 and 34 is greater than or equal to a predetermined angle, the control unit 15 may control all the displays 40a, 40b and 40c such that all the displays 40a, 40b, and 40c operate as one integrated interface unit. In this case, the one integrated interface unit may provide an enlarged screen as compared with the previous case. The foldable device 10 may also be implemented as various types of electronic devices having a structure in which the above-described first and second body parts 11 and 12 are coupled to each other, and arranged to rotate relative to the connection unit 35.

In an exemplary embodiment, to measure the angle between the first and second body parts 32 and 34, the first magnetic sensor unit 13 is installed on the first body part 32 and the second magnetic sensor unit 14 may be installed on the second body part 34. The control unit 15 may be installed on one of the first and second body parts 32 and 34 and electrically connected to the first and second magnetic sensor units 13 and 14. The control unit 15 may be include a central processing unit of device 30 or an application-specific control unit introduced for the purpose of measuring a dihedral angle according to the present disclosure.

In an exemplary embodiment, the angle between the first and second body parts 32 and 34 may be measured by using only two magnetic sensor units 13 and 14 installed on the first and second body parts 32 and 34, respectively. The first and second magnetic sensor units 13 and 14 may output the first and second azimuth information directed by the first and second body parts 32 and 34, respectively. In this case, the first and second azimuth information of the first and second body parts 32 and 34 may be represented by coordinates in a three-dimensional coordinate system determined based on the earth magnetic field.

In an exemplary embodiment, the first and second magnetic sensor units 13 and 14 may be implemented with magnetic fluxgate sensors. FIG. 2 illustrates an example in which first and second magnetic fluxgate sensor units 50a and 50b are installed as the first and second magnetic sensor units 13 and 14.

The first and second magnetic fluxgate sensor units 50a and 50b may be implemented, for example, as a three-axis fluxgate sensor. The three-axis fluxgate sensor may include an x-axis fluxgate element 62, a y-axis fluxgate element 64, and a z-axis fluxgate element 66 that are capable of detecting magnetic field components in three directions of x-axis, y-axis and z-axis which are orthogonal to each other.

In an exemplary embodiment, the first magnetic fluxgate sensor unit 50a may be installed on the first body part 32 such that a magnetic field measurement direction of the y-axis fluxgate element 64 is substantially parallel to the folding axis 37 direction (y-axis direction in FIG. 2), a magnetic field measurement direction of the x-axis fluxgate element 62 is substantially parallel to a first direction, and a height direction of the z-axis fluxgate element 66 is substantially parallel to a second direction. In this case, the first direction is substantially parallel to the plane of the first body part 32. The second direction may be substantially normal to the plane of the first body part 32. FIG. 2 illustrates a case where the first direction is substantially orthogonal to the folding axis 37.

In an exemplary embodiment, the second magnetic fluxgate sensor unit 50b may be installed on the second body part 34 such that the magnetic field measurement direction of the y-axis fluxgate element 64 is substantially parallel to the folding axis 37 direction, the magnetic field measurement direction of the x-axis fluxgate element 62 is substantially parallel to a third direction, and the height direction of the z-axis fluxgate element 66 is substantially parallel to the second direction. In this case, the third direction may be substantially parallel to the plane of the second body part 34, and the fourth direction may be substantially normal to the plane of the second body part 34.

In another exemplary embodiment, the first and second magnetic fluxgate sensor units 50a and 50b may not include the y-axis fluxgate element 64. Additionally or alternatively, the first and second magnetic fluxgate sensor units 50a and 50b may be implemented with a biaxial fluxgate sensor including only the x-axis and z-axis fluxgate elements 62 and 66. In this case, each arrangement direction of the x-axis and z-axis fluxgate elements 62 and 66 of each of the first and second magnetic fluxgate sensor units 50a and 50b is the same as that of a triaxial fluxgate sensor.

The first and second magnetic fluxgate sensor units 50a and 50b, which are disposed on the first and second body parts 32 and 34, respectively, may measure the angle between the first and second body parts 32 and 34 by detecting the intensity of the magnetic field applied from the outside. In addition, even when the foldable device 30 is turned off and then turned on again, the angle between the first and second body parts 32 and 34 may be accurately measured without any additional calibration. Such angle measurement may be performed by using only two magnetic fluxgate sensor units 50a and 50b. Since separate other sensors are not required, the number of sensors may be minimized and the manufacturing cost of the foldable device 10 may be reduced.

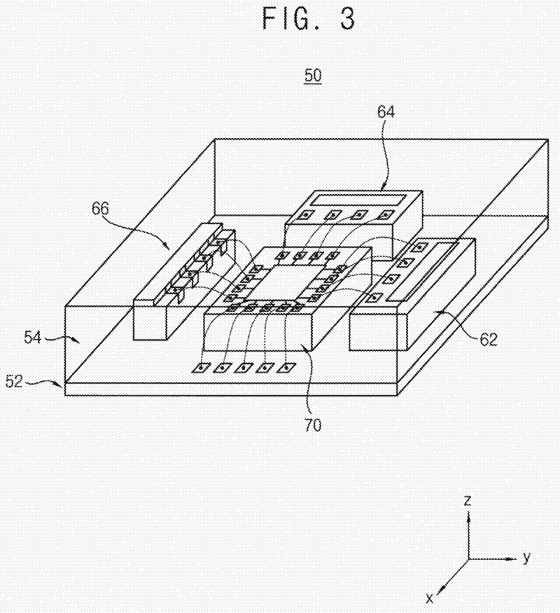

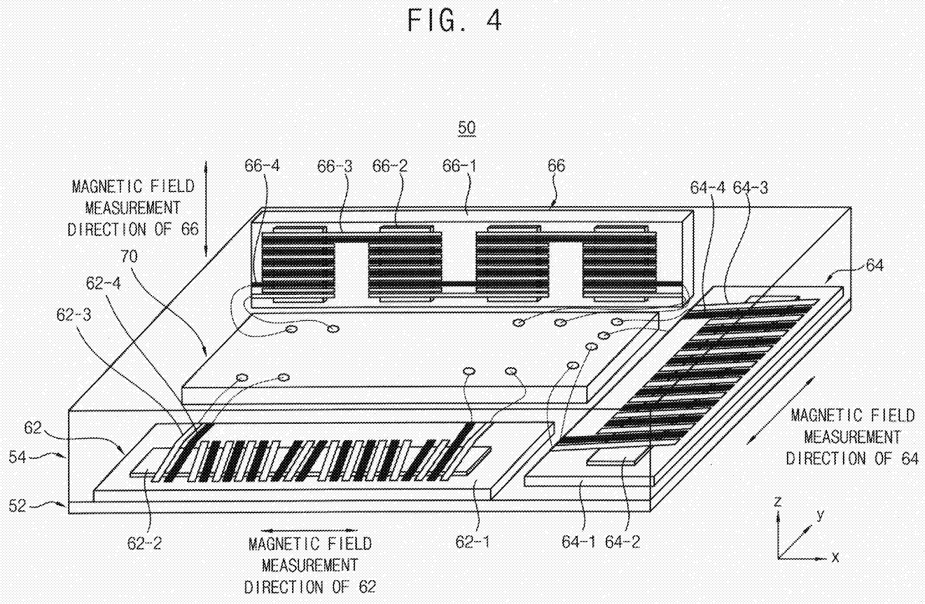

FIGS. 3 and 4 illustrate the triaxial magnetic fluxgate sensor unit 50 in further detail. Referring to FIGS. 3 and 4, the triaxial magnetic fluxgate sensor unit 50 may include a printed circuit board (PCB) 52, a triaxial fluxgate element 62, 64 and 66, a driving/detecting unit 70, and a packaging part 54 for firmly coupling the above elements 52, 62, 64, 66 and 70 to each other as one body.

The x-axis, y-axis, and z-axis fluxgate elements 62, 64 and 66 of the triaxial magnetic fluxgate sensor unit 50 may be mounted on the PCB 52 to detect magnetic field components in three directions (x, y, z-axis directions) orthogonal to each other. The x-axis fluxgate element 62 may include an insulating substrate 62-1, a bar-shaped magnetic body 62-2 extending in the x-axis direction and disposed on the insulating substrate 62-1, a drive coil 62-3 which is wound around the magnetic body 62-2 and has both ends connected to the driving/detecting unit 70, and a pickup coil 62-4 which is wound around the magnetic body 62-2 and has both ends connected to the driving/detecting unit 70. The driving coil 62-3 and the pickup coil 62-4 may be wound around the magnetic body 62-2 in the form of a solenoid coil.

The y-axis fluxgate element 64 may also be configured to be substantially the same as the x-axis fluxgate element 62. That is, the y-axis fluxgate element 64 may include an insulating substrate 64-1, a magnetic body 64-2, a driving coil 64-3, and a pickup coil 64-4. However, there is a difference only in that the bar-shaped magnetic body 64-2 extends in the y-axis direction.

The z-axis fluxgate element 66 may also include an insulating substrate 66-1, a magnetic body 66-2, a driving coil 66-3, and a pickup coil 66-4. In addition, to reduce the height of the z-axis fluxgate element 66, the magnetic body 66-2 may be configured in a form in which a plurality of low magnetic bodies 66-2 are arranged on the same plane. The plurality of magnetic bodies 66-2 may be wound with one driving coil 66-3 and one pickup coil 66-4, respectively. That is, the driving coils 66-3 wound around the plurality of magnetic bodies 66-2 may be connected in series, and the pickup coils 66-4 may also be connected in series. Each magnetic body 66-2 may extend in a cylindrical or oval shape in the z-axis direction. The magnetic fluxgate sensor unit 50 configured in this manner may reduce the height of the z-axis fluxgate element 66 in the z-axis direction and thus may be easily mounted on a small mobile electronic device such as a foldable smartphone.

The magnetic bodies 62-2, 64-2 and 66-2 may be formed of a magnetic material having low coercivity, high permeability and fast saturation magnetization. For example, the magnetic bodies 62-2, 64-2, and 66-2 may be manufactured in a bar shape having a stacked thin film structure by stacking NiFe thin films alternately with Al₂O₃ insulator thin films. These magnetic bodies 62-2, 64-2, 66-2 may have a high squareness in the form of a narrow square hysteresis loop.

The driving/detecting unit 70 may supply an AC current (e.g., a triangular wave, a sine wave, or the like) required for driving each of the triaxial fluxgate elements 62, 64 and 66 to each of the driving coils 62-3, 64-3 and 66-3. Pickup voltages may be induced in each of the pickup coils 62-4, 64-4 and 66-4 by the time-varying magnetic field generated by the driving current flowing through each of the driving coils 62-3, 64-3 and 66-3. In the profile of the pickup voltages induced in each pickup coil 62-4, 64-4 and 66-4 by the magnetization reversal characteristics of each magnetic body 62-2, 64-2 and 66-2, a positive first voltage peak and a negative second voltage peak are generated every cycle. Unless specifically blocked, an external magnetic field such as the earth's magnetic field may be applied to each pick-up coil 62-4, 64-4 and 66-4.

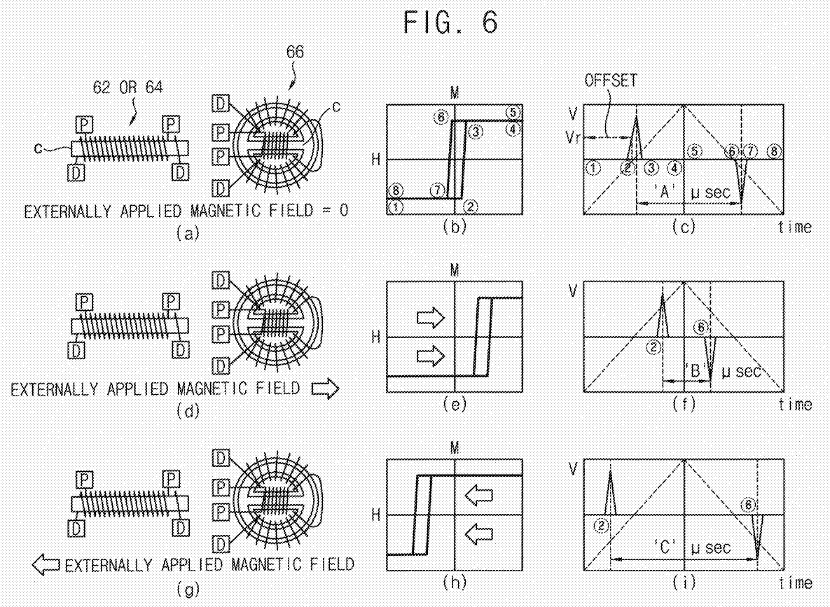

However, the spacing of the two voltage peaks may vary depending on the magnitude of the earth's magnetic field applied to each pickup coil 62-4, 64-4 and 66-4 from the outside (for details, see the description for FIG. 6). In an environment in which an earth's magnetic field is applied, the driving/detecting unit 70 may detect the pickup voltage induced in the pickup coils 62-4, 64-4, 66-4 every cycle while the AC driving current is applied to each driving coil 62-3, 64-3 and 66-3. The driving/detecting unit 70 may detect a shifted degree of the generation time point of the voltage peak included in the profile of the detected pickup voltage (the shifted degree relative to the case where the externally applied magnetic field is 0 (zero)), thereby obtaining the intensity of the earth's magnetic field.

Since the voltage peaks included in the profile of the pickup voltage may occur at two points every cycle of the AC driving current, the intensity of the earth's magnetic field may be obtained by calculating the delay between the two voltage peaks. The intensity of the earth's magnetic field may be mapped to a coordinate of one point in the three-dimensional coordinate system. The coordinate of the point may define an azimuth vector obtained by connecting the origin to the point in the three-dimensional coordinate system. The azimuth vector may be information representing a direction to which the body part 32 or 34 on which the fluxgate sensor unit 50 is installed is directed.

In this manner, a first driving/detecting unit 70a of the first magnetic fluxgate sensor unit 50a may obtain a first azimuth vector representing the direction to which the first body part 32 is directed. In addition, a second driving/detecting unit 70b of the second magnetic fluxgate sensor unit 50b may obtain a second azimuth vector representing a direction to which the first body part 32 is directed.

In obtaining the first and second azimuth vectors, although all triaxial fluxgate elements 62, 64 and 66 may be utilized as described above, it is also possible to utilize only the x-axis fluxgate element 62 and the z-axis fluxgate element 66.

The driving/detecting unit 70 may be disposed on the PCB 52 for package together with the triaxial fluxgate elements 62, 64 and 66, and electrically connected to the triaxial fluxgate elements 62, 64 and 66 through die bonding. Then, for example, they may be integrated through a molding 54 using epoxy resin.

The first and second magnetic fluxgate sensor units 50a and 50b may be implemented as the triaxial magnetic fluxgate sensor unit 50 as illustrated in FIGS. 3 and 4. The first and second magnetic fluxgate sensor units 50a and 50b may be installed at respective positions inside or outside the first and second body parts 32 and 34, respectively. For example, the first and second magnetic fluxgate sensor units 50a and 50b may be mounted on the bezel or in the housing of the first and second body parts 32 and 34, respectively.

The x-axis and y-axis fluxgate elements 62 and 64 of the first magnetic fluxgate sensor unit 50a may have magnetic field measurement directions that are substantially parallel to the plane of the first body part 32. Furthermore, the magnetic measurement direction of the z-axis fluxgate element 66 may be substantially normal to the plane of the first body part 32. For example, in some implementations, the magnetic field measurement direction of the y-axis fluxgate element 64 may be parallel with the direction of the folding axis 37, and the magnetic field measurement direction of the y-axis fluxgate element 64 may be tilted with respect to the folding axis 37.

The second magnetic fluxgate sensor unit 50b may also have the same configuration. The x-axis and y-axis fluxgate elements 62 and 64 may have magnetic field measurement directions that are substantially parallel to the plane of the second body part 34 and the magnetic measurement direction of the z-axis fluxgate element 66 may be substantially normal to the plane of the second body part 34. For example, the magnetic field measurement direction of the x-axis fluxgate element 62 may be perpendicular to the folding axis 37 while being in the plane of the second body part 34, and the magnetic field measurement direction of the y-axis fluxgate element 64 may be parallel with the direction of the folding axis 37. In order to avoid the magnetic field interference between the magnetic fluxgate sensor unit 50 and several components of the portable foldable device 30 by design, the first and second magnetic fluxgate sensor units 50a and 50b may be installed to be tilted with respect to the folding axis 37. Such installation is also substantially the same as the invention described above. This is because in measuring the angle between the two body parts 32 and 34 using only the x-axis and z-axis components of each of the magnetic fluxgate sensor units 50a and 50b, when the x-axis fluxgate element 62 is installed to be tilted with a direction perpendicular to the folding axis 37 by an angle of α, the angle measurement can be performed only by using, instead of the value [X] measured by the x-axis fluxgate element 62, the cosine value [X cos α] of the measured value. This principle is also applicable to the measurement of the angle between the two body parts 32 and 34 using all the X, Y, and Z-axis components of each of the first and second magnetic fluxgate sensor units 50a and 50b.

Throughout the specification, the phrase ‘substantially parallel’ shall be interpreted as permitting an error in the range of ±10°. Similarly, throughout the specification, the phrase ‘substantially normal direction’ shall be interpreted as permitting an error in the range of ±10°.

According to the example of FIG. 3, the first magnetic fluxgate sensor unit 50a may detect azimuth information directed by the first body part 32 while moving together with the first body part 32, and the second magnetic fluxgate sensor unit 50b may detect azimuth information directed by the second body part 34 while moving together with the second body part 34. FIG. 3 illustrates an example in which the magnetic field measurement direction of the x-axis fluxgate element 62 of each of the first and second magnetic fluxgate elements 50a and 50b is orthogonal to the direction of the folding axis 37, and the magnetic measurement direction of the y-axis fluxgate element 64 is parallel to the direction of the folding axis 37.

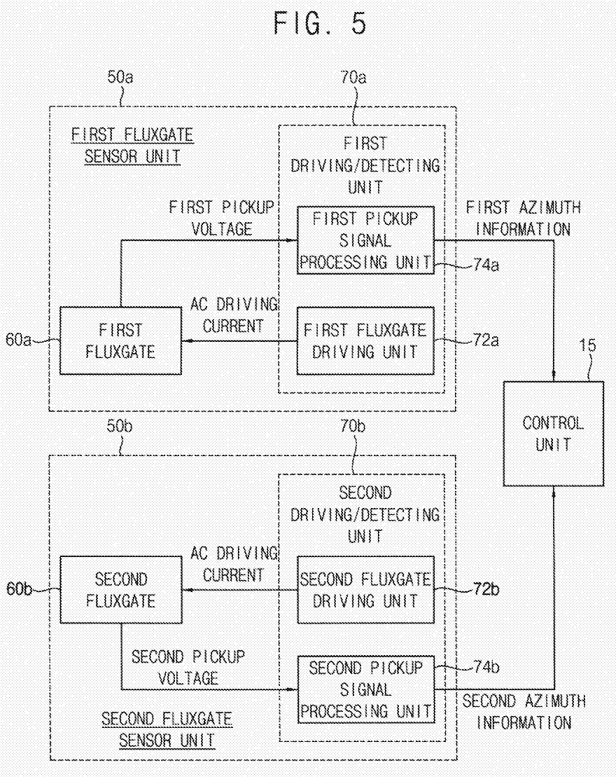

FIG. 5 is a block diagram of an apparatus for measuring an angle between two body parts of a foldable device that is implemented by using magnetic fluxgate sensor parts 50a and 50b, according to aspects of the disclosure. As illustrated in FIG. 5, the first magnetic fluxgate sensor unit 50a may include a first fluxgate 60a and the first driving/detecting unit 70a. The second magnetic fluxgate sensor unit 50b may include a second fluxgate 60b and the second driving/detecting unit 70b.

In an exemplary embodiment, the first fluxgate 60a may be a triaxial fluxgate including x-axis, y-axis and z axis fluxgate elements 62, 64 and 66. In another embodiment, the first fluxgate 60a may be a biaxial fluxgate including the x-axis 62 and the z-axis fluxgate element 66. The second fluxgate 60b may also have the same configuration as the first fluxgate 60a. in the following description, the triaxial fluxgate will be described as an example unless the biaxial fluxgate is specifically mentioned.

The first driving/detecting unit 70a may include a first fluxgate driving unit 72a and a first pickup signal processing unit 74a. The first fluxgate driving unit 72a may apply an AC driving current (e.g., an AC triangle wave current, an AC sine wave current, or the like) to driving coils 62-3, 64-3 and 66-3 of the x-axis, y-axis and z-axis fluxgate elements 62, 64 and 66 of the first fluxgate 60a. As a result, the driving coils 62-3, 64-3 and 66-3 may drive magnetic bodies 62-2, 64-2 and 66-2 through an alternating cycle of magnetic saturation (magnetization->non-magnetization->reverse magnetization->non-magnetization, and the like).

The magnetic field generated by the AC driving current flowing through the driving coils 62-3, 64-3 and 66-3 and the earth's magnetic field may pass through the x-axis, y-axis, and z-axis fluxgate elements 62, 64 and 66 of the first fluxgate 60a. Thus, voltages may be induced in the pickup coils 62-4, 64-4 and 66-4, respectively. The first pickup signal processing unit 74a may detect pickup voltages induced in the pickup coils 62-4, 64-4 and 66-4, respectively.

As described above, the first and second voltage peaks are generated in the profile of each pick-up voltage every cycle by the magnetization reversal characteristics of the magnetic bodies 62-2, 64-2 and 66-2. The time interval between the two voltage peaks may be changed depending on the magnitude and direction of the earth's magnetic field applied to the corresponding pickup coil 62-4, 64-4 or 66-4. By calculating the delay between the two voltage peaks, the intensity of the external magnetic field (i.e., the earth's magnetic field) applied to the corresponding pickup coil may be calculated.

The intensity of the external magnetic field applied to the three pickup coils 62-4, 64-4 and 66-4 may be calculated as described above. The intensities of three external magnetic fields may be mapped to the coordinates of one point in the three-dimensional coordinate system. The azimuth vector connecting from the origin to the point in the three-dimensional coordinate system may represent an azimuth vector directed by the first body part 32 to which the first magnetic fluxgate sensor unit 50a is installed. The first pickup signal processing unit 74a may provide the control unit 15 with the azimuth vector information obtained as described above.

The second driving/detecting unit 70b may also have the same configuration as the first driving/detecting unit 70a. Accordingly, the second fluxgate driving unit 72b of the second driving/detecting unit 70b may apply an AC driving current (e.g., an AC triangle wave current, an AC sine wave current, or the like) to the driving coils 62-3, 64-3 and 66-3 of the x-axis, y-axis and z-axis fluxgate elements 62, 64 and 66 of the second fluxgate 60b. The second pickup signal processing unit may calculate the intensity of the external magnetic field applied to the three pickup coils 62-4, 64-4 and 66-4, obtain the azimuth vector information directed by the second body part 34 by using the same, and provide the azimuth vector information to the control unit 15.

The first and second driving/detecting units 70a and 70b may be implemented with circuitry and/or software configured to perform the function and signal processing operation described above. For example, they may be implemented using a dedicated ASIC chip having an embedded program.

FIG. 6 is an exemplary diagram illustrating the operation of the fluxgate elements 62, 64 and 66 of the magnetic fluxgate sensor unit 50 according to aspects of the present disclosure.

Referring to FIG. 6, portions (a), (d) and (g) of FIG. 6 illustrate the structure of the fluxgate element according to an embodiment of the present disclosure. In the drawings, the bar structure fluxgate element represents the x-axis and y-axis fluxgate elements 62 and 64, and the circular structure fluxgate element represents the z-axis fluxgate element 66. In addition, ‘D’ denotes a drive coil, ‘P’ denotes a pickup coil, and ‘C’ denotes a magnetic body. Furthermore, portions (b), (e) and (h) of FIG. 6 illustrate hysteresis loops, or magnetization-magnetic field (MR) loops according to the magnetic characteristics of the magnetic body C constituting each of the fluxgate elements 62, 64 and 66. In addition, portions (c), (f), (i) of FIG. 6 illustrate the waveforms of the pickup voltages generated from the pickup coil P.

Referring to portions (a), (b) and (c) of FIG. 6, it is assumed that there is no magnetic field (i.e., earth's magnetic field) applied from the outside. When an alternating current or a triangular wave current (that is, a driving current), which is represented by a dotted line in portion (c) of FIG. 6, flows through the driving coil D, a magnetic field is formed inside the driving coil D.

When the direction of the formed magnetic field is reversed, a voltage is induced in the pickup coil P. The voltage induced in the pickup coil P may be a waveform in the form of a voltage peak indicated by a solid line in portion (c) of FIG. 6. The generation of the voltage peak is closely related to the magnetic characteristics of the magnetic body C of the fluxgate element.

That is, the voltage peak is generated because the voltage induced in the pickup coil P is proportional to the amount of change in time (that is, dM/dt) of the magnetization value of the magnetic body C. When a triangular wave current of one cycle flows through the driving coil D, the magnetization curve of the magnetic body C inside the fluxgate elements 62, 64 and 66 is changed along the trajectory of the order of \textcircled{1} to \textcircled{8} of portion (b) in FIG. 6. When the magnetic body C has a magnetic history curve having an excellent rectangularity ratio, the magnetization value may change rapidly in the section of \textcircled{2} to \textcircled{3} where the magnetization direction of the magnetic body C changes from −M to +M. A first voltage peak may be generated in the pickup coil P in a section in which a sudden change (2M) occurs in the magnetization value. Similarly, in a section of \textcircled{6} to \textcircled{7} in which one cycle of the triangular wave current is completed, a second voltage peak having a sign opposite to that of the first voltage peak may be generated in the pickup coil P. In this case, the first and second voltage peaks may be generated with the time interval T1 of ‘A’ psec.

In addition, portions (d), (e) and (f) of FIG. 6 illustrate an example in which an external magnetic field is applied from the left sides to the right sides of the fluxgate elements 62, 64 and 66. For example, when an external magnetic field is applied to the fluxgate elements 62 and 64 from left to right, as shown in portion (e) of FIG. 6, the M-H loop formed in the magnetic body C may be shifted to the right by the intensity of the external magnetic field applied to the magnetic body C.

An external magnetic field such as the earth's magnetic field may serve as a DC bias magnetic field. That is, the external magnetic field may expand a magnetic domain composed of magnetic spindles substantially parallel to the direction of applying the magnetic field inside the magnetic body C. Due to the expansion of the magnetic domain, the M-H loop may be shifted in the positive or negative direction from the origin.

In this state, when an AC triangular wave current flows through the drive coil D, a solenoid magnetic field is alternately formed left and right inside the drive coil D in accordance with the current flow in the drive coil D. In this case, since the magnetic hysteresis curve is shifted, for example, to the right, when the magnetization reversal occurs based on the same time, the generation of the peak voltage has a different behavior than when there is no external magnetic field. That is, the (+) peak voltage generated by the change of the magnetic material C from the (−) magnetization state to the (+) magnetization state occurs later than in the absence of the external magnetic field, and the (−) peak voltage generated by the change of the magnetic body C from the (+) magnetization state to (−) magnetization state occur faster than in the absence of the external magnetic field. Thus, the distance between the output peaks has a wider peak-to-peak distance than when there is no externally applied magnetic field. As shown in portion (f) of FIG. 6, the distance between the first and second voltage peaks detected by the pickup coil P is narrower than when no external magnetic field is applied. That is, the first and second voltage peaks may be generated within the time interval T2 of T2=B psec, which is smaller than T1.

Furthermore, portions (g), (h) and (i) of FIG. 6 illustrate the case where the external magnetic field is applied to the fluxgate elements 62, 64 and 66, for example, from right to left as opposed to the previous case. When the principle discussed with respect to portions (d), (e) and (f) of FIG. 6 is applied and the external magnetic field is applied from right to left to the fluxgate elements 62, 64 and 66, the distance between the first and second voltage peaks is increased, so that the time interval T3 at which the first and second voltage peaks occur is T3=C psec, which is larger than T1.

Moreover, in the solenoid type fluxgate elements 62, 64 and 66, the magnetic field B formed in the driving coil D by the driving current and the electromotive force E induced in the pickup coil P may be obtained through following Equation 1 and Equation 2, respectively.

$$\begin{matrix}B = μ nI & ( 1 ) \\ E = L ( \frac{di}{a c} ) , \\ where L = ( μ {N}^{2} S ) / l & ( 2 )\end{matrix}$$

In Equation 1, μ=4π×10⁻⁷ (Tm/A), ‘n’ is the number of turns per unit length of the driving coil D, and ‘T’ is the driving current. In Equation 2, ‘L’ is the inductance of the pick-up coil P, di/dt is the current change inducing electromotive force in the pickup coil P, ‘\grave{l}’ is a constant according to the characteristics of the magnetic material, ‘N’ is the number of windings of the pickup coil P, ‘S’ is the cross-sectional area of the pickup coil P, and ‘l’ is the average length of the magnetic path.

As confirmed through the above-described equations, the electromotive force induced in the pickup coil of the fluxgate element, that is, the pickup voltage is determined only by the characteristics of the current, the number of windings, and the magnetic material. Unlike the scheme of using an electron flow inside a sensor mainly used in a conventional sensor such as a Hall sensor, there is no possibility that problems such as change in the external environment such as temperature, electromagnetic waves, and the like are involved in the fluxgate element. Therefore, when the characteristics of the magnetic body of the fluxgate sensor 50 are fixed and the design and specification of the fluxgate element such as the current and the number of windings are determined, the azimuth data (external magnetic field components) in the magnetic field measurement direction of each triaxial fluxgate element may be obtained.

According to this operating principle, each of the fluxgate elements 62, 64 and 66 of the magnetic fluxgate sensor unit 50a or 50b may measure an externally applied magnetic field, that is, the X, Y and Z axis components of the earth's magnetic field. Thus, the first and second magnetic fluxgate sensor units 50a and 50b may output the first and second azimuth information representing the direction to which the first and second body parts 32 and 34 are directed regardless of the arrangement state of the foldable device 30 and the power on/off operation, respectively. The first and second azimuth information may be expressed as three-dimensional coordinates in a coordinate system determined based on the earth's magnetic field.

The control unit 15 may calculate the angle between the first and second body parts 32 and 34 by using the first and second azimuth information output from the first and second magnetic fluxgate sensor units 50a and 50b, respectively. In detail, since the first and second azimuth information may be mapped to three-dimensional coordinates in the three-dimensional coordinate system, which correspond to the first and second azimuth vectors, respectively. Thus, the angle between the first and second azimuth vectors may be the angle between the first and second body parts 32 and 34. The control unit 15 may measure the angle between the first and second body parts 32 and 34 by calculating the angle between the first and second azimuth vectors based on this principle. That is, the control unit 15 may measure the angle between the first and second body parts 32 and 34 through the scheme of calculating the angle between the first azimuth vector formed by the three-dimensional coordinates corresponding to the origin of the coordinate system and the first azimuth information and the second azimuth vector formed by the three-dimensional coordinates corresponding to the origin of the coordinate system and the second azimuth information.

In an exemplary embodiment, when the angle between the first and second body parts 32 and 34 is measured, the control unit 15 may perform predetermined subsequent processing in accordance with the angle between the first and second body parts 32 and 34. For example, the predetermined subsequent processing may vary the interface mode provided to the user through the first and second interface units 11 and 12. When the first and second interface units 11 and 12 are implemented as touch screen displays, the control unit 15 may vary the size of an image or picture output through the first and second interface units 11 and 12 according to the angle between the first and second body parts 32 and 34, output the image or picture only through one of the first and second interface units 11 and 12, or output different images or pictures through the first and second interface units 11 and 12. The interface modes of the first and second interface units 11 and 12 may be changed through such a scheme, and various interface mode variable operations may be implemented according to the intention of a designer without being limited to the above examples.

F1G. 7 is a flowchart of an example of a process for measuring the angle between body parts 32 and 34 of the foldable device 30, according to an exemplary embodiment.

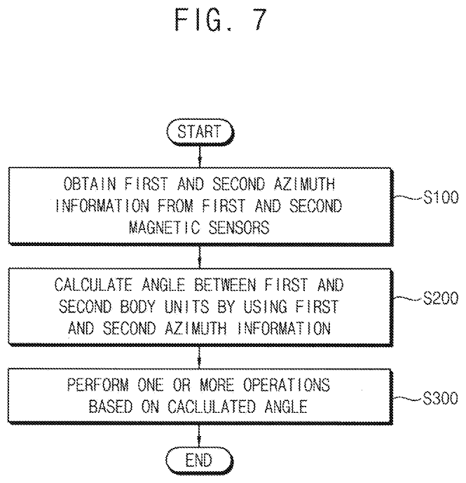

An angle measuring method of the foldable device 30 according to an embodiment of the present disclosure will be described with reference to FIG. 7. First, the first and second magnetic fluxgate sensor parts 50a and 50b may detect the positions of the first and second body parts 32 and 34, respectively, thereby generating the first and second azimuth information representing the directions in which the first and second body parts 32 and 34 are oriented.

In operation S100, the control unit 15 may receive the first and second azimuth information of the first and second body parts 32 and 34 from the first and second magnetic fluxgate sensor units 50a and 50b, respectively. The first and second magnetic fluxgate sensor units 50a and 50b may generate the first and second azimuth information based on the intensity of an externally applied magnetic field such as the earth's magnetic field, respectively.

While the drive current is applied to the drive coils 62-3, 64-3 and 66-3 of each fluxgate element 62, 64 and 66, the pickup voltages are induced in each of the pickup coils 62-4, 64-4 and 66-4 due to the magnetization inversion characteristics of the magnetic bodies 62-2, 64-2 and 66-2. In the profile of the pickup voltage, positive and negative voltage peaks may occur every cycle. In the pick-up voltage profile of one cycle, the generation time points of the first and second voltage peaks are shifted according to the intensity of an externally applied magnetic field such as the earth's magnetic field. The magnitude of the component of the earth's magnetic field applied to each fluxgate element 62, 64 and 66 may be detected based on the degree of shift of the first and second voltage peaks or a time interval between the first and second voltage peaks. The magnitudes of the triaxial direction components of the earth's magnetic field detected by each of fluxgate elements 62, 64 and 66 of the first magnetic fluxgate sensor unit 50a may be the first azimuth information that may represent the direction of the first body part 32 on which it is installed. In other words, the first azimuth information may be based on the magnitude of the external magnetic field components detected by each fluxgate element of the first magnetic fluxgate sensor unit 50a, and it may be obtained based on the generation time point of the voltage peak appearing in the pickup voltage waveform of the corresponding fluxgate element. Similarly, the magnitudes of the triaxial direction components of the earth's magnetic field detected by each of fluxgate elements 62, 64 and 66 of the second magnetic fluxgate sensor unit 50b may be the second azimuth information that may represent the direction of the second body part 34 on which it is installed. The second azimuth information may also be based on the generation time point of the voltage peak appearing in the pickup voltage waveform of the corresponding fluxgate element. A series of signal processing operations for extracting the first and second azimuth information from the pickup voltage induced in the pickup coil P may be performed by the first and second pickup signal processing units 74a and 74b.

In operation S200, the control unit 15 may calculate an angle between the first and body parts 32 and 34 by using the first and second azimuth information. More particularly, the control unit 15 may measure the angle between the first and second body parts 32 and 34 by calculating the angle between the first and second azimuth vectors.

In some implementations, the angle θ between the first and second azimuth vectors \vec{U} and \vec{V} may be obtained using the following equation.

$$cos θ = ( \frac{\vec{U} \cdot \vec{V}}{\vert \vec{U} \vert \cdot \vert \vec{V} \vert} ) \qquad ( 3 )$$

where \vec{U} is a first azimuth vector (represented by the first azimuth information) and \vec{V} a is a second azimuth vector (represented by the second azimuth information).

In operation S300, the control unit 15 may perform one or more operations based on the angle between the first and second body parts 32 and 34 calculated in operation S200. The operations may include changing the state of an interface provided to the user through the first and second interface units 11 and 12 according to the calculated angle between the first and second body parts 32 and 34.

If the first and second azimuth information provided by the first and second magnetic fluxgate sensor units 50a and 50b are not calibrated information, the control unit 15 may perform calibration processing before calculating the dihedral angle. To this end, the data storage of the control unit 15 may store in advance the magnitude of the origin offset 115 of each fluxgate element of the first and second magnetic fluxgate sensor units 50a and 50b. Furthermore, the control unit 15 may reflect measurement sensitivity gains of the fluxgate elements of the first and second magnetic fluxgate sensor units 50a and 50b since the fluxgate elements of the first and second magnetic fluxgate sensor units 50a and 50b may have different measurement sensitivity gains.

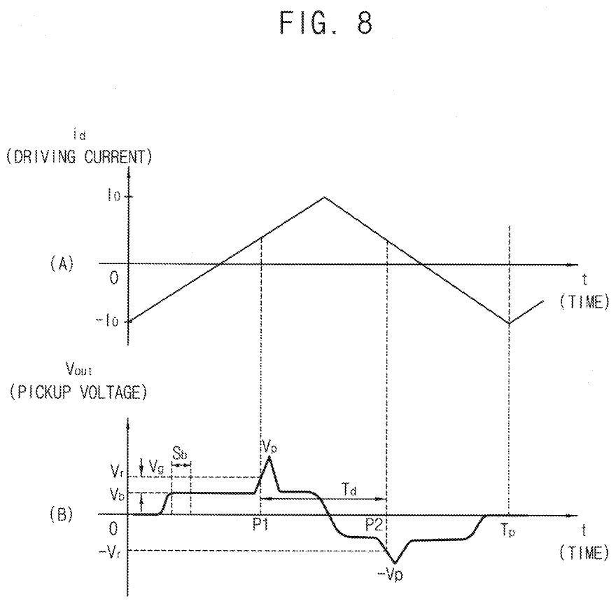

FIG. 8 shows the respective waveforms of a driving current and a pickup voltage that is generated in response to the driving current.

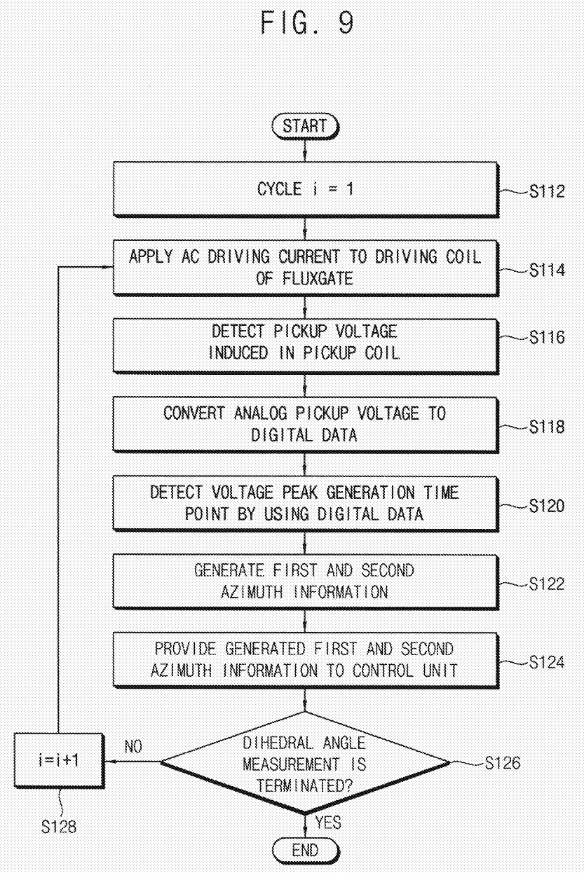

FIG. 9 is a flowchart of a process for generating first and second azimuth information representing the orientation of the first and second body paths, according to an exemplary embodiment.

The first fluxgate sensor unit 50a installed on the first body part 32 will be described as an example with reference to FIGS. 8 and 9. The following description may be equally applied to the second fluxgate 50b installed on the second body part 34. In addition, as an example, the first and second fluxgate sensor units 50a and 50b having a triaxial fluxgate element will be described. However, it is possible to measure the angle between the first and second body parts 32 and 34 only by the biaxial fluxgate element capable of detecting magnetic field components substantially parallel to the plane of each of the body parts 32 and 34 and substantially normal to the plane.

In operations S112 and. S114, the first fluxgate driving unit 72a may supply an AC triangular wave driving current to each of the driving coils 62-3, 64-3 and 66-3 of the first fluxgate 60a for one cycle as shown in (A) of FIG. 8.

While the driving current flows through each of the driving coils 62-3, 64-3 and 66-3, each of the driving coils 62-3, 64-3 and 66-3 may function as a solenoid to form a time-varying magnetic field passing through the magnetic bodies 62-2, 64-2 and 66-2. The time-varying magnetic field penetrates inside the pickup coils 62-4, 64-4 and 66-4 so that a pickup voltage Vₒᵤₜ may be induced in each pickup coil 62-4, 64-4 and 66-4 having a waveform as shown in (B) of FIG. 8. In operation S116, the first pickup signal processing unit 74a may detect analog pickup voltage (Vₒᵤₜ) signals from each of the pickup coils 62-4, 64-4, and 66-4.

In operation S118, the first pickup signal processing unit 74a may amplify the analog pickup voltage (Vₒᵤₜ) signals, perform a filtering process for removing noise, and perform signal processing such as chopping to convert it to digital data representing the pick-up voltage waveform.

In operation S120, the first pickup signal processing unit 74a may detect the generation time point of the voltage peak by using the converted digital data of the pickup voltage waveform. In the pickup voltage waveform of each of the fluxgate elements 62, 64 and 66, the generation time point of the voltage peak every cycle may be a value corresponding to the intensity of the external magnetic field applied to the corresponding fluxgate element. For example, the generation time point of the voltage peak detected in the pickup voltage waveform of the x-axis fluxgate element 62 may be a value corresponding to the magnitude of the x-axis direction component of the external magnetic field applied to the x-axis fluxgate element 62. For one cycle of the pickup voltage waveform, the voltage peak may occur twice. In an exemplary embodiment, the first pick-up signal processing unit 74a may detect the generation time point P1 of the positive first voltage peak Vp and the generation time point P2 of the negative second voltage peak −Vp in the pickup voltage waveform of each of the three fluxgate elements 62, 64, and 66 every cycle. The time interval T_{d} between the time points P1 and P2 of the two voltage peaks Vₚ and −Vₚ may be calculated.

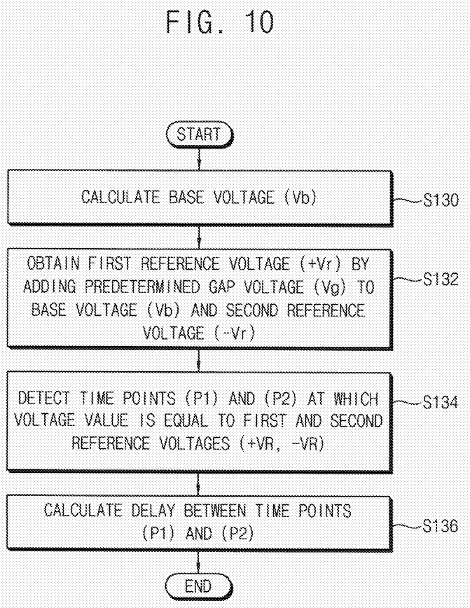

FIG. 10 illustrates an example of a process for performing operation 120. Referring to FIG. 10, operation S120, which is, for example, a method of detecting time points P1 and P2 of the two voltage peaks Vₚ and −Vₚ in the pickup voltage waveform data of the current cycle, will be described in more detail.

For example, a value representing the magnitudes of voltages of the initial predetermined section Sb may be determined from the pickup voltage waveform data of the current cycle of the x-axis fluxgate element 62, thereby obtaining the base voltage V_{b}. In operation S130, for example, the base voltage V_{b} of the current cycle may be determined as an average value, a median value, or the like of the voltages of the initial predetermined section Sb (S130).

In operation S132, the first reference voltage +Vᵣ may be obtained by adding a gap voltage V_{g} having a predetermined magnitude to the base voltage V_{b} of the current cycle. The gap voltage V_{g} may be set to a value large enough to distinguish noise from a peak voltage to avoid false detection due to noise. At the same time, a second reference voltage −Vᵣ having the same magnitude as that of the first reference voltage +Vᵣ and the opposite sign may be obtained.

In operation S134, after obtaining two positive and negative reference voltages +Vᵣ and −Vᵣ, the voltage value after the predetermined section S_{b} in the pickup voltage waveform of the current cycle may be compared with the first and second reference voltage values +Vᵣ, and −Vᵣ to detect two time points P1 and P2 at which they are equal to each other. The two detected time points P1 and P2 may be time points at which the pickup voltage enters the sections of the first and second voltage peaks +Vₚ and −Vₚ, respectively. The time intervals between the two time points P1 and P2 may be understood as a value that corresponds to the magnitude of the first direction component of the external magnetic field applied to the pick-up coil 62-4 of the x-axis fluxgate element 62 arranged to measure the magnetic field in the first direction.

It is assumed that the first pickup signal processing unit 74a outputs, for example, the magnitude of the external magnetic field applied to the x-axis fluxgate element 62, that is, the magnitude of the first direction component of the earth's magnetic field as 10-bit digital data. In this case, one cycle may be divided into 1024 time points to detect the two time points P1 and P2. Of course, the two time points P1 and P2 may be detected by dividing one cycle into, for example, more than 1024 time points. When the externally applied magnetic field is 0 (zero), the time interval of the two time points P1 and P2 may be output as a value of 512. Depending on the magnitude of the first direction component of the externally applied magnetic field applied to the pick-up coil 62-4 of the x-axis fluxgate element 62, the value of the time interval between the two time points P1 and P2 may be greater than or less than ‘512’. For example, it is assumed that the x-axis fluxgate element 62 is manufactured such that the time interval between the two time points P1 and P2 increases by ‘70’ from ‘512’ to ‘582’ when the external magnetic field of 0.5 Gauss is applied. When the sign of the externally applied magnetic field is changed and a magnetic field of −0.5 Gauss is applied to the pickup coil 62-4, the time interval between the two time points P1 and P2 may be output as 432 which is decreased by 70 from 512. This increase may be a value that varies linearly according to the magnitude of the first direction component of the externally applied magnetic field applied to the pickup coil 62-4 of the x-axis fluxgate element 62. When a magnetic field of 0.25 Gauss is applied from the outside, the time interval between the two time points P1 and P2 may be measured as having occurred as much as 35 displacements.

The first pickup signal processing unit 74b of the first magnetic fluxgate sensor unit 50a may obtain the generation time points P1 and P2 of the two voltage picks Vₚ and −Vₚ from the pickup voltage waveform data of the current cycle of the z-axis fluxgate element 66 arranged to measure the magnetic field in the second direction in the same manner as above.

The second magnetic fluxgate sensor unit 50b may also have the same configuration. The second pickup signal processing unit 74b may obtain the generation time points P1 and P2 of the two voltage picks Vₚ and −Vₚ from the pickup voltage waveform data of the current cycle of each of the x-axis and y-axis fluxgate elements 62 and 64 arranged to measure the magnetic fields in the third and fourth directions in the same manner as above.

The first pick-up signal processing unit 74a may calculate the first delay between the first and second voltage peak generation time points P1 and P2 measured every cycle in the pick-up voltage waveform of the x-axis fluxgate element 62 of the first magnetic fluxgate sensor unit 50a. In addition, in operation S136, the second delay between two voltage peak generation time points P1 and P2 measured every cycle in the pickup voltage waveform of the z-axis fluxgate element 62 of the first magnetic fluxgate sensor unit 50a may be calculated. In the same manner, the second pickup signal processor 74a may calculate the third and fourth delays between the voltage peak generation time points P1 and P2 in two pickup voltage waveforms of the x-axis and z-axis fluxgate elements 62 and 66 of the second magnetic fluxgate sensor unit 50b.

In each of the first and second magnetic fluxgate sensor units 50a and 50b, in operation S122, the information about the delay between two voltage peak generation time points as described above every cycle in step S120 may be generated as the first and second azimuth information of the first and second body parts 32 and 34.

Operation S122 will now be described in detail. According to an exemplary embodiment, to calculate the angle between the first and second body portions 32, 34, it is necessary to measure the external magnetic field components in the directions substantially parallel to the plane of each of the first and second body parts 32 and 34 and substantially normal to the plane. When the external magnetic field component in the direction substantially parallel to the plane of each of the first and second body parts 32 and 34 is measured, the detection information of both the x-axis and y-axis fluxgate elements 62 and 64 may be used, but detection information of either one may be used. However, the magnetic field measurement direction of the fluxgate element used for external magnetic field measurement needs to be a direction that is not parallel to the folding axis 37.

The first driving/detecting unit 70a may obtain the first and second delays from each pickup voltage waveform of, for example, the x-axis and z-axis fluxgate element 62 and 66 of the first fluxgate 60a every cycle. The first and second delays may be the first azimuth information of a corresponding cycle. Similarly, the second driving/detecting unit 70b may obtain the third and fourth delays (the voltage peak generation time point information) from each pickup voltage waveform of, for example, the x-axis and z-axis fluxgate element 62 and 66 of the second fluxgate 60b every cycle. The third and fourth delays may be the second azimuth information of a corresponding cycle.

In another exemplary embodiment, the first pick-up signal processing unit 74a may further calculate the fifth delay between the two voltage peak generation time points P1 and P2 measured every cycle in the pick-up voltage waveform of the y-axis fluxgate element 64 of the first magnetic fluxgate sensor unit 50a. . This information may be further included in the first azimuth information. The second pick-up signal processing unit 74b may also calculate the sixth delay between the two voltage peak generation time points P1 and P2 measured every cycle in the pick-up voltage waveform of the y-axis fluxgate element 64 of the second magnetic fluxgate sensor unit 50a. This information may be further included in the second azimuth information.

Each of the first and second azimuth information may be understood as coordinate information which is mapped to one point in the three-dimensional coordinate system which has a folding axis 37 of the first and second body parts 32 and 34 as the y-axis and a point on the folding axis 37 as the origin. The first azimuth information may be a first azimuth vector representing a direction to which the first body part 32 is directed in the three-dimensional coordinate system. Similarly, the second azimuth information may be a second azimuth vector representing a direction to which the second body 34 is directed in the three-dimensional coordinate system.

In the three-dimensional coordinate system having an origin at a point on the folding axis 37 of the first and second body parts 32 and 34, the first azimuth information, which is composed of the first and second delay information or the first, second and fifth delay information, may be mapped to the coordinate of one point in the three-dimensional coordinate system to serve as information representing the azimuth phase θ1 to which the first body part 32 is directed. Similarly, the third and fourth delay information or the third, fourth and sixth delay information are also mapped to the coordinate of another point of the three-dimensional coordinate system to serve as information representing the azimuth phase θ2 to which the second body part 34 is directed.

Initial calibration may be performed for each of the first and second magnetic fluxgate sensor units 50a and 50b in order to convert the first, second or fifth delay information and the second, fourth or sixth delay information detected by the first and second pickup signal processing units 74a and 74b, respectively into the azimuth information directed by the second body part 34. The origin point offset 115 of each fluxgate element 62, 64 and 66 of the first and second magnetic fluxgate sensor units 50a and 50b obtained through the calibration may be used when calculating the first and second azimuth information. In the initial calibration process, measurement sensitivity gains may be obtained to reflect the measurement sensitivity gains of the fluxgate elements. The origin offset 115 and the measurement sensitivity gains may be applied to collected signals and/or data in the first and second magnetic fluxgate sensor units 50a and 50b or in the control unit 15. The manner in which the origin offset 115 is used to calculate the first and/or second azimuth information is discussed further below.

In operation S124, the first and second azimuth information obtained as described above may be provided to the control unit 15 as information representing the azimuth angles of the first and second body parts 32 and 34, respectively. The first and second azimuth information may be provided to the control unit 15 every cycle or after being collected for several cycles.

In operations S126 and 128, the sequence of operations S114 to S124 for obtaining the first and second azimuth information may be repeatedly performed continuously every cycle of the AC driving current until an instruction to end the dihedral angle measurement is given.

As some implementations, instead of obtaining the delay between the first and second voltage peaks generation time points P1 and P in operation S120, only the generation time point P1 of the first voltage peak +Vₚ and the generation time point P2 of the second voltage peak −Vₚ may be obtained. The magnitude of the external magnetic field may be known only with the information about the generation time point P1 of the first voltage peak +Vₚ or the generation time point P2 of the second voltage peak −Vₚ. The magnitude of the external magnetic field may be known by using the time interval between the voltage peak generation time point when no external magnetic field is applied and the voltage peak generation time point when the external magnetic field is applied.

As another exemplary embodiment, in calculating the voltage peak generation time point (see operations S118 and S120), the voltage peak generation time point may be calculated using the analog pickup voltage waveform as it is without conversion to digital data. To this end, it is necessary to provide a separate circuit for detecting the generation time point of the voltage peak.

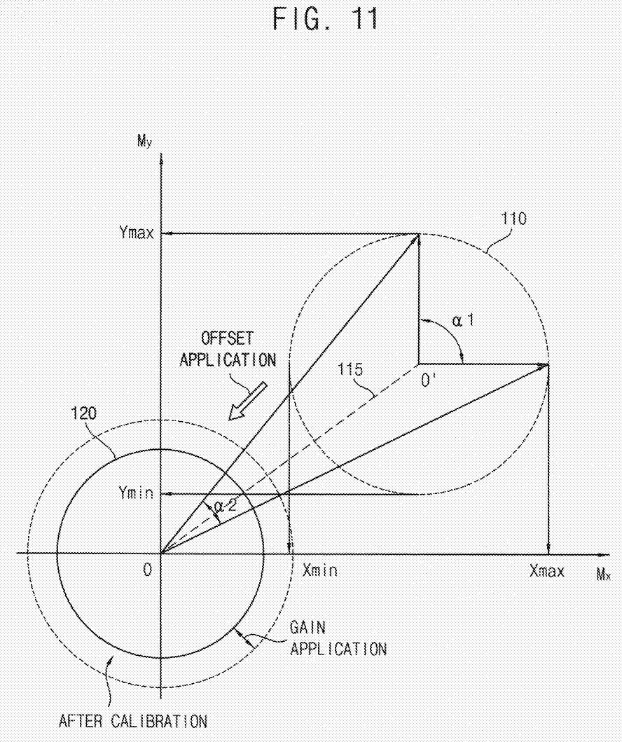

FIG. 11 is a diagram illustrating a process for calibrating a magnetic fluxgate sensor unit according to an exemplary embodiment of the present disclosure.

In the initial manufacturing state of the magnetic fluxgate sensor unit 50, the center point of the magnitude of the external magnetic field measured by each fluxgate element 62, 64 and 66 may be spaced apart from the origin O by a predetermined distance. The predetermined distance is referred to herein as the origin offset 115. When this origin offset 115 is not calibrated, an error may occur in measuring the angle between the two body parts 32 and 34. When the external magnetic field is not applied from the starting time point of the one cycle of the pickup voltage in the pickup voltage waveform of each fluxgate element of the magnetic fluxgate sensor unit 50, the origin offset 115 may be defined as the delay to the generation time point of the voltage peak or the intensity of the external magnetic field equivalent to it.

For example, it is assumed that the first and second magnetic fluxgate sensor units 50a and 50b respectively installed in the two body parts 32 and 34 of the foldable device 30 are in an initial state in which the origin offset 115 originally possessed by the first and second magnetic fluxgate sensor units 50a and 50b has not yet been calibrated. In the state where the two body parts 32 and 34 are fully folded up or down or unfolded to be completely coplanar, that is, the dihedral angle θ is 0 or 180 degrees, for example, the magnitudes of the x-axis and y-axis components of the external magnetic field may be measured while the two body parts 32 and 34 are positioned parallel to the XY plane while being rotated 360 degrees. The center of the trajectory 110 of the x-axis and y-axis components of the external magnetic field obtained in the measurement may be spaced apart by the origin offset 115 from the origin O as shown in FIG. 11. When the angle is measured in this state, accurate angle measurement may not be achieved. For example, in the state where the first magnetic fluxgate sensor unit 50a outputs the maximum value Xmax of the x-axis component of the external magnetic field and the second magnetic fluxgate sensor unit 50b outputs the maximum value Ymax of the y-axis component, before the origin offset 115 is calibrated, the angle between the two body parts 32 and 34 is measured as α1, but the actual angle is α2 measured at the origin O. That is, when the origin offset 115 is not calibrated, an error of ‘α2−α1’ may occur. The origin offset 115 may be calculated in advance and applied to the calculation of the dihedral angle. Thus, it is possible to more accurately calculate the dihedral angle.

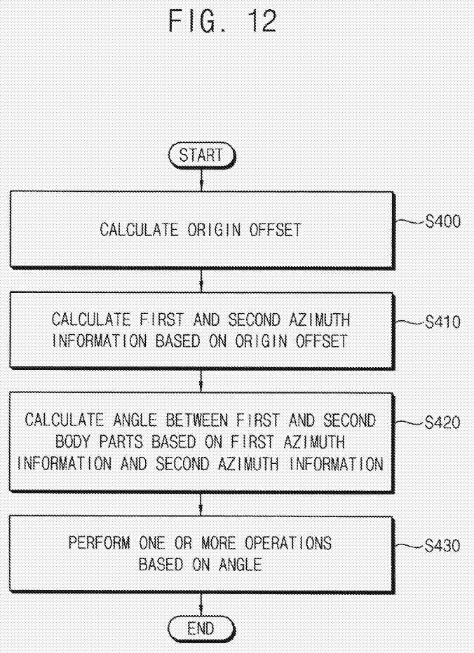

FIG. 12 is a flowchart illustrating a process for measuring an angle between two body parts of a folding device by applying calibration for magnetic fluxgate sensor units according to an exemplary embodiment.

Referring to FIG. 12, first, the origin offset 115 of the first and second magnetic fluxgate sensor units 50a and 50b installed in the two body parts 32 and 34 of the foldable device 30 may be calculated. In operation S400, an indication of the origin offset 115 may be generated and stored in the data storage unit.

In an exemplary embodiment, when the two body parts 32 and 34 of the foldable device 30 are fully folded up or down or unfolded to be completely coplanar (that is, the dihedral angle θ is 0 or 180 degrees), the foldable device 30 is rotated 360 degrees while being maintained to be parallel to the xy plane.

During the rotation, the voltage peak generation time point in the pick-up voltage waveform of each fluxgate element 62, 64 and 66 of each of the first and second magnetic fluxgate sensor units 50a and 50b is measured, respectively to obtain change trajectory at the voltage peak generation time peak on the xy plane.

For example, while the foldable device 30 is rotated 360 degrees, the change trajectory at the voltage peak generation time point in the pickup voltage waveform of each fluxgate element of each of the first and second magnetic fluxgate sensor units 50a and 50b may be a circle or ellipse, a crushed circle, or the like.

As shown in FIG. 11, the change trajectory 110 at the voltage peak generation time point may have the maximum or minimum value Xmax or Xmin in the x-axis direction, and the maximum or minimum value Ymax or Ymin in the y-axis direction. Similarly, in the yz plane, the change trajectory of the voltage peak generation time point in the pickup voltage waveform of each fluxgate element may be obtained in the same manner. As a result, the maximum and minimum values Zmax and Zmin in the z-axis direction may be obtained. The center O′ of the change trajectory at the voltage peak generation time point in the three axis directions thus obtained does not coincide with the origin O. The degree of mismatch may correspond to the origin offset 115.

The origin offset 115 initially possessed by each of the fluxgate elements 62, 64 and 66 of the first and second magnetic fluxgate sensor units 50a and 50b may be calculated by using the following equation.

X_offset=(Xmax+Xmin)/2

Y_offset=(Ymax+Ymin)/2

Z_offset=(Zmax+Zmin)/2 (4)

The origin offset sizes obtained for each fluxgate element 62, 64 and 66 of the first and second magnetic fluxgate sensor units 50a and 50b may be stored in the data storage unit (not shown) in advance.

When calculating the angle between the two body parts 32 and 34, the origin offset stored in advance stored in the data storage unit may be applied. According to an exemplary embodiment, the origin offset may be utilized when the magnetic fluxgate sensor units 50a and 50b detect the first and second azimuth information. That is, in operation S410, when the first and second azimuth information is generated in operation S122 of the flowchart of FIG. 9, the indication of the origin offset stored in the data storage unit of the first and second magnetic fluxgate sensor units 50a and 50b may be retrieved and used in the generation of the first and second fluxgate information.

Thus, the first and second azimuth information provided to the control unit 15 by the first and second magnetic fluxgate sensor units 50a and 50b in operation S124 is azimuth information to which the origin offset is applied. In operation S420, the control unit 15 may calculate the angle between the first and second body parts 32 and 34 by using the first and second azimuth information that is obtained based on the origin offset.

In addition, the control unit 15 may perform predetermined control or processing based on the calculated dihedral angle.

As another example, the origin offset may be utilized by the control unit 15. In this case, an indication of the origin offset may be stored in advance in the data storage unit of the control unit 15. In operation S124, the first and second magnetic fluxgate sensor units 50a and 50b may provide the control unit 15 with the first and second azimuth information in a state where the origin offset is not calibrated. In operation S200 of FIG. 7, the control unit 15 may read the origin offset from the data storage unit and use it as a basis for modifying the first and second azimuth information provided by the first and second magnetic fluxgate sensor units 50a and 50b. As described above, the angle between the first and second body parts 32 and 34 may be calculated by using the first and second azimuth information that is calibrated based on the origin offset by the control unit 15.

Additionally or alternatively, in some implementations, the measurement sensitivity characteristics of the triaxial fluxgate elements 62, 64 and 66 of the magnetic fluxgate sensor unit 50 may be different from each other. That is, in FIG. 12, the x-axis measurement sensitivity Sx=Xmax−Xmin and the y-axis measurement sensitivity Sy=Ymax−Ymin may be different from each other. The z-axis measurement sensitivity Sz=Zmax−Zmin may also be different from the x-axis measurement sensitivity Sx and/or the y-axis measurement sensitivity Sy. If the measurement sensitivity characteristics of the three axes are not the same, the measurement sensitivity characteristic trajectory is expressed as a distorted sphere rather than a perfect sphere. The measurement sensitivity gains may be applied to each axis to normalize them to eliminate a deviation in measurement sensitivity characteristics due to difference in three-axis manufacturing and the influence of the magnetic field applied from the periphery. In this case, the measurement sensitivity gain may be defined as the ratio between the difference between the maximum and minimum values of the magnetic field used in the calibration of the origin offset and the difference between the maximum and minimum values of the measured voltage peak generation time point. The measurement sensitivity gain may be applied by multiplying the measurement sensitivity gain based on the origin offset at the measured voltage peak generation time point. The value obtained by applying the measurement sensitivity gain may be the intensity of the magnetic field according to the gain type, and may be a unit vector of each of the x, y and z axes.

Furthermore, the origin offset can also be obtained by other methods. As another scheme to obtain the origin offset, magnetic fields with the same magnitude but the opposite direction to each other may be applied in both directions of the x-axis from the outside and then, each voltage peak generation time point may be obtained, such that the distance between the center value coordinates of the two values and the origin may be calculated as the origin offset of the x-axis. In the same manner, both the y-axis and the z-axis may be measured to calculate offset sizes of the x, y and z axes.

At step S430, the control unit performs an operation based on the calculated dihedral angle. As noted above, the operation may include changing the state of a user interface is provided by using the body parts 32 and 34 and/or any other suitable action.

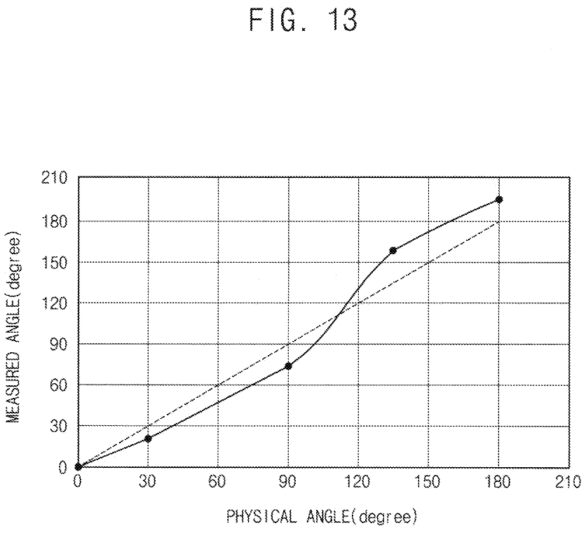

FIG. 13 is a plot illustrating the accuracy of the process(es) for measuring an angle between two body parts of a foldable device, which are discussed with respect to FIGS. 1-12. In the plot of FIG. 13, the horizontal axis is the actual angle between the two body parts 32 and 34, and the vertical axis is a value obtained by measuring the angle between the two body parts 32 and 34 by using the dihedral angle measuring apparatus 20 configured by arranging the magnetic fluxgate sensor units 50a and 50b on the two body parts 32 and 34 according to an embodiment of the present disclosure. Although there is some error between the actual and measured angles, it may be understood that the overall trends of the two values varying from 0 to 180 degrees is similar to each other. When the pattern of an error that occurs between the actual and measured dihedral angles is analyzed, an error compensation that can offset the error may be obtained. When the error compensation is applied to the measured dihedral angle, a dihedral angle with a higher accuracy may be obtained.

As described above, a method and an apparatus for measuring an angle between two body parts have been described using a portable foldable device as an example. However, there is no particular limitation to the application of the present disclosure. Without being limited to the above-described embodiments, the present disclosure may be widely used to measure the angle between two objects by using a magnetic sensor.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. An apparatus comprising:
a first body part;
a second body part that is rotatably coupled to the first body part;
a first magnetic sensor unit disposed in the first body part, the first magnetic sensor unit being configured to: detect an intensity of an external magnetic field applied to the first magnetic sensor unit, and generate first azimuth information representing a direction in which the first body part is oriented;
a second magnetic sensor unit disposed in the second body, the second magnetic sensor unit being and configured to detect an intensity of an external magnetic field applied to the second magnetic sensor unit, and generate second azimuth information representing a direction in which the second body part is oriented; and
a control unit configured to receive the first and second azimuth information from the first and second magnetic sensor units, respectively, and calculate an angle between the first and second body parts.

2. The apparatus of claim 1, wherein:
in a three-dimensional coordinate system having an origin on an axis of rotation of the first body relative to the second body, the first azimuth information includes a first azimuth vector connecting the origin to a first point defined by external magnetic field components in first and second directions,
the second azimuth information includes a second azimuth vector connecting the origin to a second point defined by external magnetic field components in third and fourth directions,
the first direction is substantially parallel to a plane of the first body part,
the second direction is substantially normal to the plane of the first body part,
the third direction is substantially parallel to a plane of the second body part, and
the fourth direction is substantially normal to the plane of the second body part.

3. The apparatus of claim 2, wherein calculating an angle between the first and second body parts includes calculating an angle between the first and second azimuth vectors.

4. The apparatus of claim 1, wherein:
the first magnetic sensor unit includes a first fluxgate element configured to detect an external magnetic field component in a first direction, a second fluxgate element configured to detect an external magnetic field component in a second direction, and a first driving/detecting unit configured to apply at least first and second driving currents to the first and second fluxgate elements, respectively, and receive first and second pickup voltages from the first and second fluxgate elements, respectively,
the second magnetic sensor unit includes a third fluxgate element configured to detect an external magnetic field component in a third direction, a fourth fluxgate element configured to detect an external magnetic field component in a fourth direction, and a second driving/detecting unit configured to apply at least third and fourth driving currents to the third and fourth fluxgate elements, respectively, and receive third and fourth pickup voltages from the third and fourth fluxgate elements, respectively, and
the first direction is substantially parallel to a plane of the first body part,
the second direction is substantially normal to the plane of the first body part,
the third direction is substantially parallel to a plane of the second body part, and
the fourth direction is a substantially normal to the plane of the second body part.

5. The apparatus of claim 4, wherein:
each of the first fluxgate element, the second fluxgate element, the third fluxgate element, and the fourth fluxgate element includes a respective driving coil and a respective pickup coil that is wound on a respective magnetic body,
the first driving/detecting unit is configured to calculate the first azimuth information based on a shift of respective peaks of the first and second pickup voltages that occur in a same driving period, and
the second driving/detecting unit is configured to calculate the second azimuth information based on a shift of respective peaks of the third and fourth pickup voltages that occur in a same driving period.

6. The apparatus of claim 1, further comprising first and second interface units provided in the first and second body parts, respectively, wherein the control unit is configured to cause the first and second interface units to operate as one of an integrated interface or a split interface depending on a size of the calculated angle.

7. The apparatus of claim 4, wherein:
the first magnetic sensor unit is configured to store a first origin offset and use the first origin offset at least in part as a basis for calculating the first azimuth information, and
the second magnetic sensor unit is configured to store a second origin offset and use the second origin offset at least in part as a basis for calculating the second azimuth information.

8. The apparatus of claim 4, wherein the control unit is configured to:
store a first origin offset associated with the first magnetic sensor unit and modify the first azimuth information based on the first magnetic sensor unit; and
store a second origin offset associated with the second magnetic sensor unit and modify the second azimuth information based on the second magnetic sensor unit.

9. The apparatus of claim 1, wherein:
the first body part includes a first display,
the second body part includes a second display,
the first display and the second are arranged to form a single plane when the apparatus is an unfolded state, and
the first display and the second display are arranged to face each other when the apparatus is in a folded state.

10. A method of measuring an angle between first and second body parts of a foldable device, comprising:
generating first azimuth information representing a direction in which the first body part is oriented based on an intensity of an external magnetic field at a first magnetic sensor unit, the first magnetic sensor unit being disposed in the first body part;
generating second azimuth information representing a direction in which the second body part is oriented based on an intensity of the external magnetic field at a second magnetic sensor unit, the second magnetic sensor unit being disposed in the second body part; and
calculating, by a control unit, an angle between the first and second body parts by using the first and second azimuth information received from the first and second magnetic sensor units.

11. The method of claim 10, further comprising changing a state of an interface of the foldable device based on a calculated size of the angle.

12. The method of claim 10, wherein:
in a three-dimensional coordinate system having an origin on an axis of rotation of the first body relative to the second body, the first azimuth information includes a first azimuth vector connecting the origin to a first point defined by external magnetic field components in at least first and second directions,
the second azimuth information includes a second azimuth vector connecting the origin to a second point defined by external magnetic field components in third and fourth directions,
the first direction is substantially parallel to a plane of the first body part,
the second direction is substantially normal to the plane of the first body part,
the third direction is substantially parallel to a plane of the second body part, and
the fourth direction is substantially normal to the plane of the second body part.

13. The method of claim 12, wherein:
the first magnetic sensor unit includes a first fluxgate element configured to detect an external magnetic field component in a first direction, a second fluxgate element configured to detect an external magnetic field component in a second direction, and a first driving/detecting unit,
the second magnetic sensor unit includes a third fluxgate element configured to detect an external magnetic field component in a third direction, a fourth fluxgate element configured to detect an external magnetic field component in a fourth direction, and a second driving/detecting unit,
each of the first fluxgate element, the second fluxgate element, the third fluxgate element, and the fourth fluxgate element includes a respective driving coil and a respective pickup coil that is wound on a respective magnetic body,
generating the first azimuth information includes: detecting at least first and second pickup voltages induced in the respective pickup coils of the first and second fluxgate elements; detecting a first peak of the first pickup voltage and a second peak of the second pickup voltage; and calculating a first shift of the first peak and a second shift of the second peak due to the external magnetic field components in the first and second directions, respectively, and
generating the second azimuth information includes: detecting at least third and fourth pickup voltages induced in the respective pickup coils of the third and fourth fluxgate elements; detecting a third peak of the third pickup voltage and a fourth peak of the fourth pickup voltage; and calculating a third shift of the third peak and a fourth shift of the fourth peak due to the external magnetic field components in the third and fourth directions, respectively.

14. The method of claim 13, wherein during a same driving cycle:
calculating the first shift includes determining a first representative voltage over a predetermined initial section of the first pickup voltage, calculating a first reference voltage by summing the first representative voltage and a first gap voltage, and determining a first time at which the first pickup voltage with time equals to the first reference voltage as a first peak occurrence time;
calculating the second shift includes determining a second representative voltage over a predetermined initial section of the second pickup voltage, calculating a second reference voltage by summing the second representative voltage and a second gap voltage, and determining a second time at which the second pickup voltage with time equals to the second reference voltage as a second peak occurrence time;
calculating the third shift includes determining a third representative voltage over a predetermined initial section of the third pickup voltage, calculating a third reference voltage by summing the third representative voltage and a third gap voltage, and determining a third time at which the third pickup voltage with time equals to the third reference voltage as a third peak occurrence time;
calculating the fourth shift includes determining a fourth representative voltage over a predetermined initial section of the fourth pickup voltage, calculating a fourth reference voltage by summing the fourth representative voltage and a fourth gap voltage, and determining a fourth time at which the fourth pickup voltage with time equals to the fourth reference voltage as a fourth peak occurrence time.

15. The method of claim 13, further comprising calibrating the first and second magnetic sensors to remove origin offsets thereof.

16. The method of claim 15, wherein the calibrating comprises:
calculating first and second origin offsets of the first and second fluxgate elements and storing the first and second origin offsets in a data storage unit;
calculating third and fourth origin offsets of the third and fourth fluxgate elements of the second magnetic sensor unit and storing the third and fourth origin offset magnitudes in the data storage unit; and
applying the first to fourth origin offsets when calculating the angle between the first and second body parts.

17. The method of claim 16, wherein:
the first origin offset and the second origin offset are used for generating the first azimuth information; and
the third origin offset and the fourth origin offset are used for generating the second azimuth information.

18. The method of claim 16, wherein the angle between the first body part and the second body part is calculated, by the control unit, by applying the first origin offset, and the second origin offset to the first azimuth information, and the third origin offset, and the fourth origin offset to the second azimuth information.

19. The method of claim 16, wherein the first origin offset, the second origin offset, the third origin offset, and the fourth origin offset are calculated based on trajectories of peaks in the first pickup voltage, the second pickup voltage, the third pickup voltage, and the fourth pickup voltage while the foldable device is positioned parallel to at least two of xy, yz and zx planes and rotated 360 degrees.

20. The method of claim 15, wherein the calibrating comprises:
obtaining measurement sensitivities in x-axis, y-axis, and z-axis directions of each fluxgate element of the first and second magnetic sensor units;
obtaining a measurement sensitivity gain for each of the measurement sensitivities in the x-axis, y-axis, and z-axis directions; and
removing a deviation between the measurement sensitivities in the x-axis, y-axis, and z-axis directions based on the measurement sensitivity gains for the measurement sensitivities in the x-axis, y-axis, and z-axis directions, and
wherein each of the measurement sensitivity gains for the measurement sensitivities in the x-axis, y-axis, and z-axis directions is determined based on a ratio of: (i) a difference between a maximum value and a minimum value of a calibration magnetic field used for calibrating the origin offset and (ii) a difference between maximum and minimum of voltage peak occurrence time in corresponding pickup voltage.
